(19) United States
(12) Patent Application Publication
(10) Pub. No.: US 2026/0031100 A1
(43) Pub. Date: Jan. 29, 2026

(54) VOICE ACQUISITION DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Shuhei SHIMANOE, Nisshin-shi (JP); Takashi TAKAZAWA, Nisshin-shi (JP); Tomoki TANEMURA, Nisshin-shi (JP); Masaaki KAWAUCHI, Nisshin-shi (JP)

(21) Appl. No.: 19/213,313

(22) Filed: May 20, 2025

(30) Foreign Application Priority Data
Jul. 26, 2024 (JP) 2024-120862

(51) Int. Cl. G10L 25/84; G10K 11/178; H04R 1/08

(52) U.S. Cl. CPC G10L 25/84; G10K 11/17854; H04R 1/08

(57) ABSTRACT

A voice acquisition device is adapted to a voice recognition system that recognizes a voice of a speaker present in a closed space formed by components including a skeletal component and a plate-shaped component. The voice acquisition device includes a speech microphone, a noise microphone, and a signal processor. The speech microphone acquires a sound from a region where the speaker is located, the region located in the closed space. The noise microphone is located to acquire a lower level of the sound from the region than the speech microphone. The noise microphone is located to acquire a higher level of a sound emitted from the plate-shaped component compared to a sound emitted from the skeletal component among sounds caused by vibrations propagating from outside of the closed space. The signal processor reduces a noise based on input signals.

### CROSS REFERENCE TO RELATED APPLICATION

This application is based on Japanese Patent Application No. 2024-120862 filed on Jul. 26, 2024, the disclosure of which is incorporated herein by reference.

### TECHNICAL FIELD

The present disclosure relates to a voice acquisition device.

### BACKGROUND

A voice acquisition device may be adapted to a voice recognition system. The voice recognition system may recognize the voice of a speaker present in a closed space such as a vehicle cabin.

### SUMMARY

The present disclosure describes voice acquisition device that includes a speech microphone, a noise microphone and a signal processor.

### BRIEF DESCRIPTION OF DRAWINGS

FIG. 1 is a schematic view of a vehicle equipped with a voice acquisition device according to a first embodiment.

FIG. 2 is a schematic diagram showing a frame and an outer panel included in a vehicle ceiling taken along line II-II in FIG. 1.

FIG. 3 is a cross-sectional view showing a part of the vehicle ceiling.

FIG. 4 is an enlarged view of a portion IV in FIG. 3.

FIG. 5 is a schematic diagram showing a signal processor included in the voice acquisition device according to the first embodiment.

FIG. 6 is an explanatory diagram for explaining a vibration source and a vibration propagation path of a vehicle.

FIG. 7 is an explanatory diagram for explaining noises included in diffuse noise.

FIG. 8 is a graph for explaining sound pressures of noise components contained in diffuse noise.

FIG. 9 is a graph showing the relationship between the distance between a speech microphone and a noise microphone and coherence.

FIG. 10 is a cross-sectional view showing a part of a vehicle ceiling on which a voice acquisition device according to a second embodiment mounts.

FIG. 11 is a schematic diagram showing a signal processor included in a voice acquisition device according to the second embodiment.

FIG. 12 is a schematic diagram showing a signal processor included in a voice acquisition device according to a third embodiment.

FIG. 13 is a schematic diagram showing a signal processor included in a voice acquisition device according to a fourth embodiment.

FIG. 14 is a cross-sectional view showing a part of a vehicle ceiling on which a voice acquisition device according to a fifth embodiment mounts.

FIG. 15 is an explanatory diagram for explaining a sound signal acquired when there is one noise microphone.

FIG. 16 is an explanatory diagram for explaining a sound signal acquired when there are two noise microphones.

FIG. 17 is a cross-sectional view showing a part of a vehicle ceiling on which a voice acquisition device according to a sixth embodiment mounts.

FIG. 18 is a graph illustrating diffuse noise captured by a noise microphone included in a voice acquisition device according to a sixth embodiment.

FIG. 19 is a cross-sectional view showing a noise microphone and its surrounding members provided in a voice acquisition device according to a seventh embodiment.

FIG. 20 is a cross-sectional view showing a part of a vehicle ceiling on which a voice acquisition device according to an eighth embodiment mounts.

FIG. 21 is a cross-sectional view showing a speech microphone, a noise microphone, and a multilayer printed circuit board provided in a voice acquisition device according to an eighth embodiment.

FIG. 22 is a plan view showing the speech microphone, the noise microphone, and the multilayer printed circuit board as viewed in the direction of the arrow XXII in FIG. 21.

FIG. 23 is a cross-sectional view showing a part of a vehicle ceiling on which a voice acquisition device according to a ninth embodiment mounts.

FIG. 24 is a cross-sectional view showing a part of a vehicle ceiling on which a voice acquisition device according to a tenth embodiment mounts.

### DETAILED DESCRIPTION

When using a voice recognition system in a vehicle cabin, noises such as road noise, wind noise, air conditioning noise, and voices of other people are provided to the speaking microphone along with the speaker's voice, and these noises may significantly reduce the voice recognition rate of the voice recognition system.

One method to prevent the degradation of voice recognition rate caused by noise in the vehicle cabin may be a microphone array system using multiple microphones. The microphone array system may reduce noise by utilizing the time difference between arrivals of voice signals of multiple channels input from multiple microphones, and outputs a target voice, which is the voice of a speaker, with emphasis. The microphone array system may be effective in reducing noise that is highly directional, such as the wind noise of an air conditioner or the voices of other people (hereinafter referred to as “directional noise”). However, for noise with low directionality, such as driving noise and wind noise that are generated by vibration of the entire vehicle (hereinafter referred to as “diffuse noise”), information regarding the arrival time difference of sound signals from multiple channels may become unclear. Therefore, the noise reduction effect of the microphone array system may be lower for diffuse noise than for directional noise.

As a method for preventing a decrease in voice recognition rate due to diffuse noise, a voice acquisition device may remove diffuse noise by using an adaptive filter. The voice acquisition device may include a speech microphone and a noise microphone that capture the voice of a speaker and noise within a vehicle cabin, a vibration sensor that captures vibrations of the vehicle, and a signal processor. In addition, the speech microphone may also be referred to as a voice acquisition microphone, the noise microphone may also be referred to as a noise acquisition microphone, and the signal processor may also be referred to as a noise reduction circuit. The signal processor may extract, from among the sound signals acquired by the noise microphone, those that have a high correlation with the signal acquired by the vibration sensor as diffuse noise in the vehicle cabin. The diffuse noise may be then reduced by subtracting the sound signal extracted as the diffuse noise from the sound signal acquired by the speech microphone.

Since the voice acquisition device described above includes a vibration sensor, the number of parts increases and the signal processor may be complicated. Furthermore, the mounting positions of the speech microphone and the noise microphone may also be required to consider. Therefore, it may be difficult for this noise microphone to capture noise with a high sound pressure level that contributes greatly to reducing diffuse noise. As a result, the voice recognition device described above may experience a degrading signal-to-noise ratio (hereinafter referred to as SNR), which may result in a lower speech recognition rate for the speaker. Note that SNR is an abbreviation for Signal Noise Ratio.

According to an aspect of the present disclosure, a voice acquisition device is adapted to a voice recognition system that recognizes a voice of a speaker present in a closed space formed by components including a skeletal component and a plate-shapedcomponent. The voice acquisition device includes a speech microphone, a noise microphone, and a signal processor. The speech microphone acquires a sound from a region where the speaker is located, the region located in the closed space. The noise microphone is located to acquire a lower level of the sound from the region than the speech microphone. The noise microphone is located to acquire a higher level of a sound emitted from the plate-shaped component compared to a sound emitted from the skeletal component among sounds caused by vibrations propagating from outside of the closed space. The signal processor reduces a noise based on input signals. The input signals include a time-series sound signal acquired by the speech microphone, and a time-series sound signal acquired by the noise microphone.

According to this, among the components forming the closed space, the plate-shaped components have a larger surface area compared to the skeletal components and a higher efficiency of emitting vibration sound into the air. Therefore, by attaching the noise microphone to more easily capture the sound emitted from the plate-shaped components than from the skeletal components, the noise microphone can capture the noise with a high sound pressure level among the various noises with different frequency characteristics included in the diffuse noise captured by the speech microphone. Consequently, the signal processor can remove the noise with a high sound pressure level that significantly contributes to the reduction of diffuse noise from the sound signal including speech and noise captured by the speech microphone, thereby increasing the amount of reduction of the diffuse noise. As a result, the voice acquisition device of this disclosure can improve the SNR and enhance the speaker's voice recognition rate.

Furthermore, the voice acquisition device of this disclosure does not require a vibration sensor, unlike a voice acquisition device in a related field. Therefore, the voice acquisition device of this disclosure can reduce the number of components and simplify the signal processor compared to the voice acquisition device in the related field.

Note that reference numerals in parentheses attached to components and the like indicate an example of correspondence between the components and the like and specific components and the like described in an embodiment to be described below.

Embodiments of the present disclosure will now be described with reference to the drawings. In the following embodiments, the same or equivalent portions are denoted by the same reference numerals, and the description thereof will be omitted.

### First Embodiment

The following describes a first embodiment. A voice acquisition device according to the first embodiment is used in a voice recognition system. The term “voice” described in the present disclosure may also be referred to as, for example, a term “sound”, a term “audio”, and a term “speech”. The voice recognition system includes a voice acquisition device that acquires the voice of a speaker present in a closed space, and a voice recognition engine that recognizes the information indicated by the voice acquired by the voice acquisition device and outputs control signals to various devices such as a navigation device or an air conditioning device. The wording “acquire” may also be referred to as a wording “pick up” or a wording “capture” in the present disclosure.

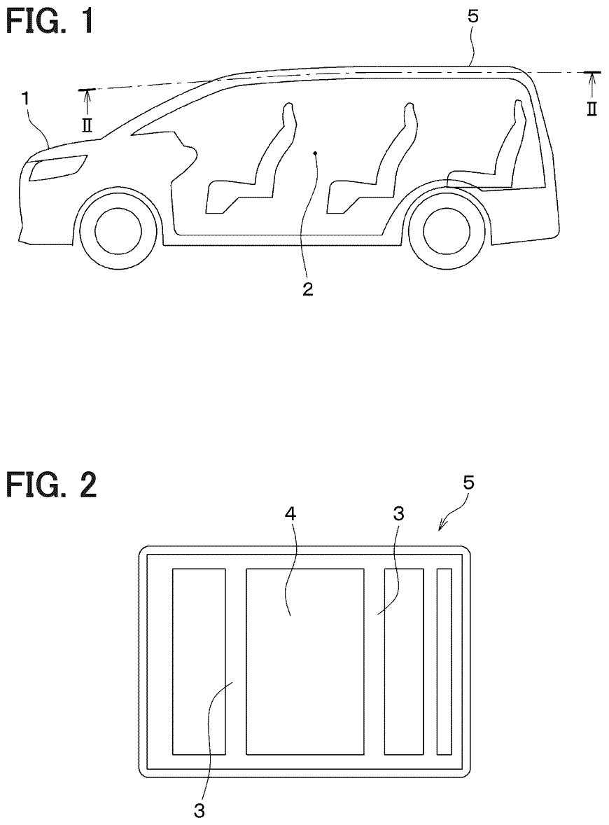

As shown in FIGS. 1 to 4, the voice acquisition device according to this embodiment is adapted to a vehicle 1 as a movable body, and acquires voices uttered by passengers in a vehicle interior space 2. That is, the vehicle interior space 2 described in the present embodiment is an example of a closed space inside a movable body in which a speaker is present. The vehicle interior space 2 includes various parts having a frame 3 as a skeletal component and an outer panel 4 as a plate-shaped component. The frame 3 and the outer panel 4 are connected by welding or adhesive. In the vehicle interior space 2, an interior material 6 is provided on the vehicle lower side (i.e., the seat side) for the frame 3 and the outer panel 4 that are included in the vehicle ceiling 5. The interior material 6 is fixed to a protrusion (not shown) provided on the frame 3. In the following description, the region in the vehicle interior space 2 below the interior material 6 on the ceiling is referred to as the “region 7 where a speaker is present” or “region 7”.

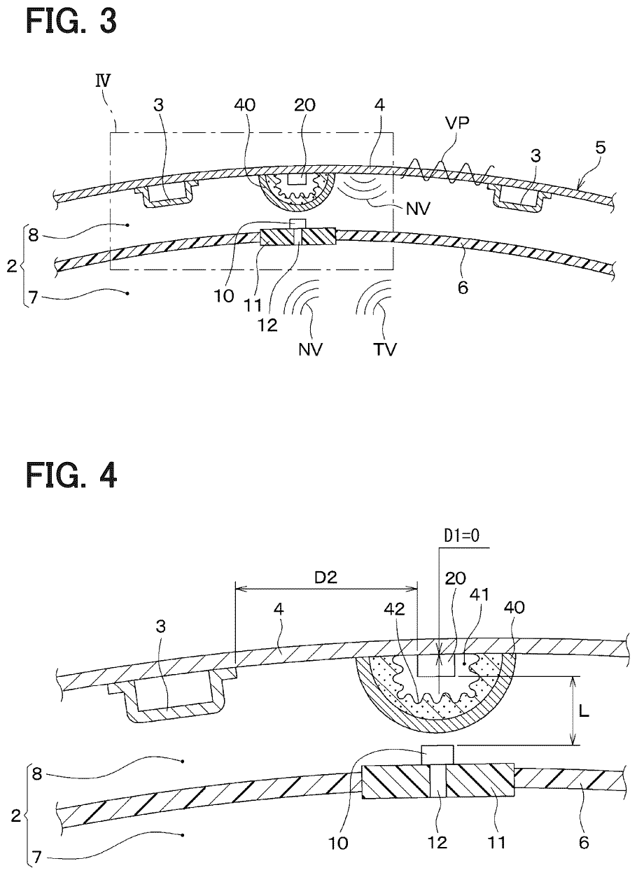

As shown in FIGS. 3 to 5, the voice acquisition device includes, for example, a speech microphone 10, a noise microphone 20, and a signal processor 30. Each of the speech microphone 10 and the noise microphone 20 converts the acquired sound into an electrical signal, and outputs the electrical signal to the signal processor 30.

As shown in FIGS. 3 and 4, the speech microphone 10 is disposed so as to acquire sounds from the region 7 in the vehicle interior space 2 where a speaker is present. The speech microphone 10 is provided in the space 8 between the outer panel 4 and the interior material 6, for example, while being attached to a support part 11. The support part 11 is fixed to, for example, the interior material 6. The support part 11 has a hole 12 through which a sound can pass (hereinafter referred to as a “sound hole 12”). The sound hole 12 in the support part 11 communicates between the region 7 in the vehicle interior space 2 where the speaker is present and the speech microphone 10. This makes it easier for the speech microphone 10 to acquire the sound from the region 7 in the vehicle interior space 2 where the speaker is present. It should be noted that noise exists in the region 7 where the speaker is present. Therefore, the speech microphone 10 acquires a noise within the vehicle cabin as well as the speaker's voice as the target sound to be acquired. In FIG. 3, the symbol NV indicates noise in the vehicle interior, and the symbol TV indicates the speaker's voice.

The noise microphone 20 is positioned so that it is less likely to acquire the sound from the region 7 where the speaker is present than the speech microphone 10, but is more likely to acquire the sound that is propagated and then emitted from outside the vehicle interior space 2 to the outer panel 4. Therefore, the noise microphone 20 is attached directly to the outer panel 4 that is included in the vehicle ceiling 5. In detail, the noise microphone 20 is attached to the outer panel 4 which has a higher efficiency of radiating vibration sound into the air than the frame 3. The efficiency of radiating vibration noise into the air is determined by, for example, the thickness, density, Young's modulus, area, and Poisson's ratio of the member. In this embodiment, the outer panel 4 on which the noise microphone 20 is attached has an area larger than that of the frame 3. The noise microphone 20 is not limited to being attached directly to the outer panel 4, but may be attached via a support part (not shown), for example. Further, the distance D1 between the noise microphone 20 and the outer panel 4 is shorter than the distance D2 between the noise microphone 20 and the frame 3. In the first embodiment, since the noise microphone 20 is directly attached to the outer panel 4, the distance D1 between the noise microphone 20 and the outer panel 4 is zero.

In order to increase the coherence between the sound acquired by the speech microphone 10 and the sound acquired by the noise microphone 20, the distance L between the speech microphone 10 and the noise microphone 20 is set to 1 meter or less. The reason for setting the distance L to 1 meter or less will be described later.

The noise microphone 20 is provided in the space 8 between the outer panel 4 and the interior material 6 that are included in the vehicle ceiling 5. That is, the interior material 6 is provided on a side of the region 7 where the speaker is present that faces a portion of the outer panel 4 where the noise microphone 20 is attached. Therefore, the interior material 6 has soundproofing and sound-absorbing functions to make it difficult for the noise microphone 20 to pick up the sound from the region 7 where the speaker is present.

Furthermore, a box-shaped soundproofing material 40 is provided so as to surround the noise microphone 20. The structure of the soundproofing material 40 is characterized by combining the effect of metal sound insulation with materials and structures that provide sound absorption effects on the inside. The soundproofing material 40 covers the periphery of the noise microphone 20 except for the portion on the outer panel 4 side. An inner space 41 is formed inside the box-shaped soundproofing material 40. The noise microphone 20 is disposed in the inner space 41 of the soundproofing material 40. An inner wall surface 42 of the soundproofing material 40 that forms the inner space 41 (hereinafter referred to as “the inner wall surface 42 of the soundproofing material 40”) has a shape having projections and recesses. The soundproofing material 40 is capable of absorbing sound by multiple reflection due to the unevenness of the inner wall surface 42. Further, the inner wall surfaces 42 of the soundproofing material 40 are structured such that the surfaces facing each other across the inner space 41 are not parallel to each other. This structure includes, for example, that the outer panel 4 and the inner wall surface 42 of the soundproofing material 40 facing the outer panel 4 are non-parallel. Thus, it is possible for the soundproofing material 40 to prevent sound from repeatedly reflecting in the inner space 41 and causing resonance. Therefore, it is possible to prevent the frequency characteristics of the sound signal radiated from the outer panel 4 and picked up by the noise microphone 20 from being changed due to resonance within the soundproofing material 40. The noise microphone 20 is covered with the soundproofing material 40 on all sides except the outer panel 4 side, such that it is difficult for the noise microphone 20 to pick up sound from the region 7 where the speaker is present, and is easier for the noise microphone 20 to pick up the sound emitted from the outer panel 4.

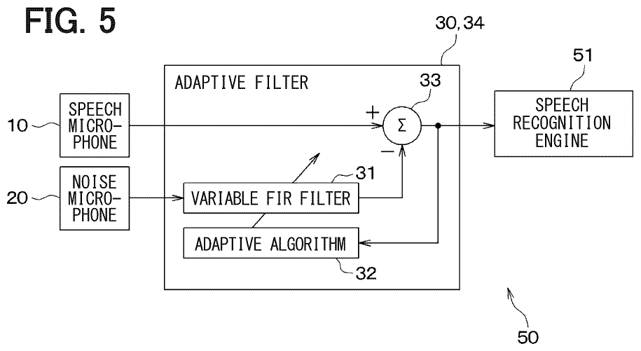

As shown in FIG. 5, the signal processor 30 includes an adaptive filter 34 that reduces diffuse noise using a time-series sound signal acquired by the speech microphone 10 and a time-series sound signal acquired by the noise microphone 20 as input signals. The adaptive filter 34 includes, for example, a variable FIR filter 31, an adaptive algorithm execution unit 32, and an adder 33. IIR is an abbreviation for Infinite Impulse Response. As the adaptive algorithm, for example, an LMS algorithm or an RLS algorithm is adopted. LMS stands for least mean square, and RLS stands for recursive least square.

The variable FIR filter 31 adjusts the amplitude and phase of the sound signal acquired by the noise microphone 20, and outputs the adjusted sound signal to the adder 33. The adder 33 adds a sound signal obtained by inverting the adjusted sound signal input from the variable FIR filter 31 to the sound signal acquired by the speech microphone 10. That is, the adder 33 subtracts the sound signal acquired by the noise microphone 20 and whose amplitude and phase have been adjusted by the variable FIR filter 31 from the sound signal acquired by the speech microphone 10 through signal processing. As a result, the sound signal output from the adder 33 is a sound signal acquired by the speech microphone 10 with the noise acquired by the noise microphone 20 reduced, making the speaker's voice stand out. The sound signal output from the adder 33 is output to the adaptive algorithm execution unit 32 and to a voice recognition engine 51 included in the voice recognition system 50. The adaptive algorithm execution unit 32 processes the sound signal output from the adder 33 using an adaptive algorithm, and automatically changes the filter coefficients of the variable FIR filter 31.

The voice recognition engine 51 mainly includes a microcomputer having a processor for performing control processing and arithmetic processing, and a memory for storing programs, data, and the like. The processor includes a CPU and an MPU. The memory includes various non-transient tangible storage media such as ROM, RAM, and non-volatile rewritable memory. The voice recognition engine 51 recognizes voice information indicated by the speaker's voice based on the sound signal acquired from the voice acquisition device, and outputs a control signal corresponding to the voice information to various in-vehicle devices such as a navigation device or an air conditioning device.

Here, the significance of attaching the noise microphone 20 to the outer panel 4 that is included in the vehicle ceiling 5 will be described.

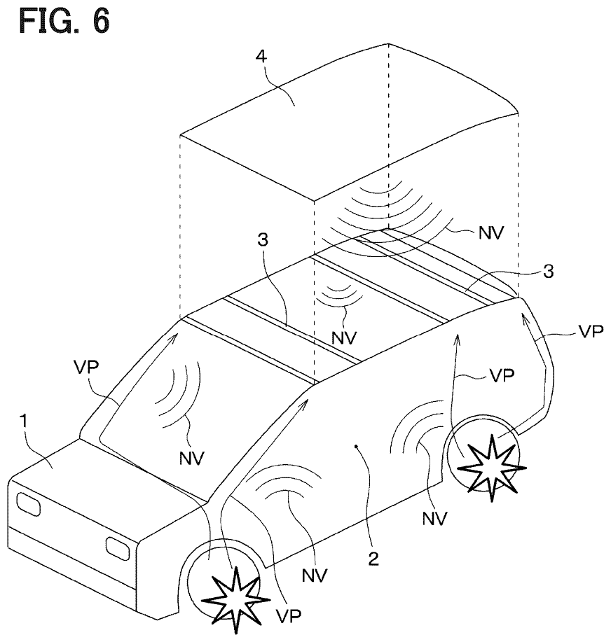

As shown in FIG. 6, vibrations caused by driving noise are generated by the tires of the running vehicle 1 and unevenness on the road surface, and the source of the vibrations is considered to be near the wheel housings and suspensions. As indicated by the arrow VP in FIG. 6, the vibration propagates through solid objects such as the frame 3 that is included in the vehicle body, and the propagated vibration re-emits sound NV from each part of the vehicle 1, becoming diffuse noise. There are many different vehicle components that re-radiate such sounds. Among these components, the outer panel 4 of the vehicle ceiling 5 has a larger vibrating area than the frame 3, and therefore can be said to be a part that emits noise with a high sound pressure level among the multiple noises contained in the diffuse noise in the vehicle interior space 2. In FIG. 6, in order to distinguish between the vibration noise NV emitted from the outer panel 4 of the vehicle ceiling 5 and the vibration noise NV emitted from the frame 3 of the vehicle ceiling 5, the outer panel 4 of the vehicle ceiling 5 is depicted at a position away from the vehicle body.

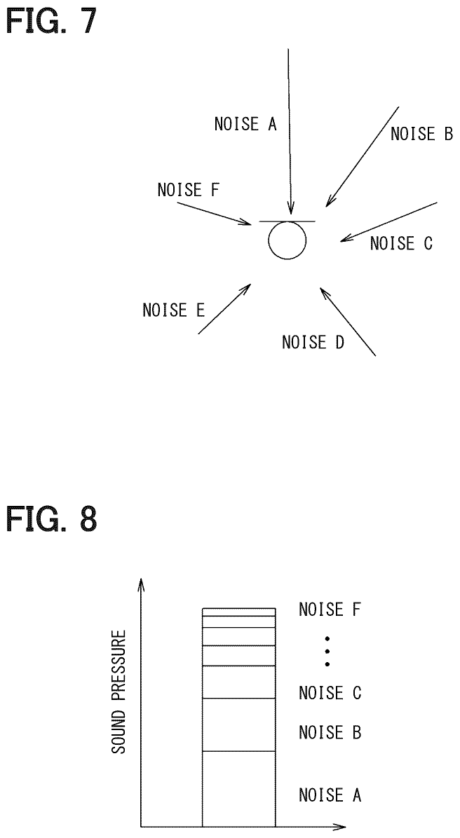

FIG. 7 shows that noises A to F contained in the diffuse noise picked up by the speech microphone 10 have different sound pressures for each direction. FIG. 8 also shows that among the multiple noises A to F contained in the diffuse noise, noise A has the highest sound pressure. Noise A corresponds to sound emitted from a predetermined outer panel 4 of the vehicle ceiling 5. Noises B and C correspond to sounds emitted from, for example, the frame 3 of the vehicle ceiling 5 or another outer panel 4. Each of the noises A to F has a different frequency characteristic and phase because the sound is emitted from a different location. Therefore, unless the noise A that is picked up by the speech microphone 10 is itself picked up by the noise microphone 20, it is not possible to reduce the noise A with a high sound pressure level even if the sound signal picked up by the speech microphone 10 is processed. In contrast, in this embodiment, by installing a noise microphone on the outer panel 4 of the vehicle ceiling 5, it is possible to capture noise A, which has the highest sound pressure among the diffuse noises captured by the speech microphone 10. Then, in the signal processor 30, signal processing is performed to subtract the noise A acquired by the noise microphone 20 from the sound signal acquired by the speech microphone 10, thereby making it possible to increase the improvement in SNR.

The following formula 1 shows that the improvement in SNR can be increased by reducing noise A with high sound pressure.

$$Δ SNR = 20 {log}_{10} ( \frac{S}{\sqrt{\sum {N}_{B ∼ F}^{2}}} ) - 20 {log}_{10} ( \frac{S}{\sqrt{\sum {N}_{A ∼ F}^{2}}} ) \qquad ( Formula 1 )$$

In addition, in the formula 1, ΔSNR indicates the improvement amount of the SNR of the sound signal obtained by the speech microphone 10 and processed by the signal processor 30. S indicates the speaker's voice which is the target sound, NA to F indicate noises A to F, and NB to F indicate noises B to F. Moreover, the first term on the right side indicates the SNR in a state where only the noise A among the noises A to F is reduced, and the second term indicates the SNR in a state where the noises A to F are not reduced. The state in which only the noise A among the noises A to F is reduced corresponds to the sound signal after the noise has been reduced by signal processing in the signal processor 30. The state in which noises A to F are not reduced corresponds to the sound signal obtained by the speech microphone 10 before noise reduction.

As shown in the Formula 1, assuming that S (i.e., the speaker's voice) does not enter the noise microphone 20 and S does not change due to signal processing, the voice acquisition device can increase ΔSNR by reducing the noise A, which has the highest sound pressure, from the sound signal captured by the speech microphone 10. For example, if the noise microphone 20 is provided at a location different from the outer panel 4, the noise microphone 20 can pick up any one of the noises B to F. In this case, any one of the noises B to F having a low sound pressure can be reduced from the sound signal acquired by the speech microphone 10 by signal processing. In contrast, the voice acquisition device of the first embodiment can reduce noise A, which has the highest sound pressure, from the sound signal captured by the speech microphone 10, and can therefore increase the ΔSNR compared to a configuration that reduces one of the noises B to F, which have lower sound pressure.

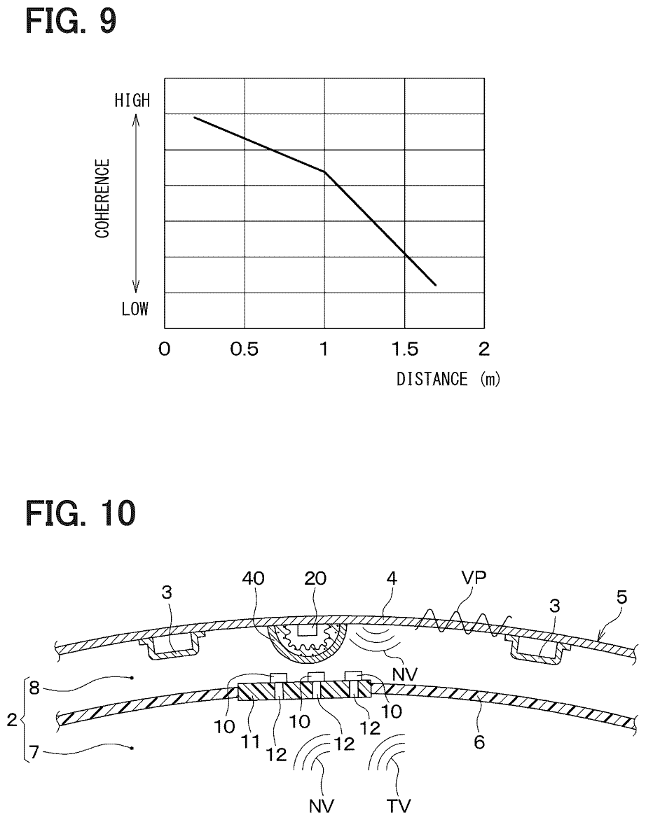

Furthermore, the inventors in the present applications conducted an experiment regarding the coherence between the sound signal acquired by the noise microphone 20 and the sound signal acquired by the speech microphone 10. The results are shown in FIG. 9. The horizontal axis in FIG. 9 indicates the distance between the noise microphone 20 and the speech microphone 10. The vertical axis represents the coherence between the sound signal acquired by the noise microphone 20 and the sound signal acquired by the speech microphone 10.

This experiment was carried out by installing multiple noise microphones 20 on the outer panel 4 of the vehicle ceiling 5, and installing the speech microphone 10 on the vehicle ceiling 5 as shown in FIG. 3. Then, the vehicle 1 was driven, and driving noise was acquired by the multiple noise microphones 20 and the speech microphone 10. Then, for each noise microphone 20, the distance L between the noise microphone 20 and the speech microphone 10 and the coherence were evaluated.

As a result of the experiment, it was found that as shown in FIG. 9, when the distance L between the speech microphone 10 and the noise microphone 20 is greater than 1 meter, the rate of reduction in coherence increases. Therefore, by setting the distance L between the speech microphone 10 and the noise microphone 20 to 1 meter or less, the coherence between the speech microphone 10 and the noise microphone 20 can be increased. Therefore, the effect of reducing diffuse noise by the signal processor 30 becomes greater, and the SNR and the voice recognition rate can be improved.

Coherence indicates the degree of association between two sets of time series data by frequency, expressed as a value ranging from 0 (i.e., no association at all) to 1 (i.e., complete association). The definition of coherence for time series data x(t) and y(t) is shown in Formula 2.

$${Coh}_{xy} ( ω ) = \frac{{\vert E [ \vert X ( ω ) \vert \vert Y ( ω ) \vert {e}^{i ( {θ}_{Y} - {θ}_{X} )} ] \vert}^{2}}{E [ {\vert X ( ω ) \vert}^{2} ] E [ {\vert Y ( ω ) \vert}^{2} ]} \qquad ( Formula 2 )$$

In addition, in the formula 2, X(ω) and Y(ω) are frequency characteristics obtained by Fourier transforming x(t) and y(t). ei(θY-θx) represents the phase shift at a certain frequency ω among x(t), X(ω), and Y(ω). If the phase difference between the two signals x and y is always the same, when calculating the expected value E, ei(θY-θx) is constant and can be taken outside the expected value, and the numerator and denominator of the above formula 2 will be equal, and the coherence will be 1 (i.e., maximum). If the phase difference is not always constant but fluctuates, ei(θY-θx) cannot be outside the expected value, and since the phase difference changes over time, the amplitude becomes smaller when the average is calculated. Therefore, the coherence approaches zero.

As a result of the above experiment, it was found that it may be desirable to install the noise microphone 20 within 1 meter of the speech microphone 10.

The voice acquisition device of the first embodiment described above has the following advantages.
(1) In the first embodiment, the speech microphone 10 captures the sound from the region 7 where a speaker is present within the vehicle interior space 2 formed by parts including the frame 3 and the outer panel 4. On the other hand, the noise microphone 20 is located so as to pick up less sound from the region 7 where the speaker is present than the speech microphone 10, and to pick up more sound radiated from the outer panel 4 than from the frame 3. According to this, among the parts that form the vehicle interior space 2, the outer panel 4 has a larger area than the frame 3, and has a high efficiency of emitting vibration noise into the air. Therefore, the noise microphone 20 can pick up noise with a high sound pressure level among multiple noises with different frequency characteristics contained in the diffuse noise picked up by the speech microphone 10. Therefore, the signal processor 30 can remove noise with a high sound pressure level that contributes greatly to reducing diffuse noise from the sound signal containing speech and noise acquired by the speech microphone 10, thereby increasing the amount of reduction in diffuse noise. As a result, the voice acquisition device can improve the SNR and improve the speech recognition rate for the speaker.

Moreover, the voice acquisition device of the first embodiment does not require a vibration sensor. Therefore, the voice acquisition device of the first embodiment can reduce the number of parts and simplify the signal processor 30.
(2) In the first embodiment, the noise microphone 20 is attached directly to the outer panel 4 or via a support part fixed to the outer panel 4. Accordingly, the configuration of the first embodiment can obtain a larger signal level of the vibration sound propagating to and emitted from the outer panel 4 than a configuration in which the noise microphone 20 is attached to the frame 3.
(3) In the first embodiment, the distance D1 between the noise microphone 20 and the outer panel 4 is closer than the distance D2 between the noise microphone 20 and the frame 3. Accordingly, the configuration of the first embodiment can obtain a large signal level of the vibration sound propagating to and radiating from the outer panel 4. In addition, the distance D1 between the noise microphone 20 and the outer panel 4 being closer than the distance D2 between the noise microphone 20 and the frame 3 means that the difference between the two distances is greater than the manufacturing tolerance that would occur if the two distances were made the same. Specifically, the distance D1 between the noise microphone 20 and the outer panel 4 should be 90% or less of the distance D2 between the noise microphone 20 and the frame 3, and more preferably, less than half. In the first embodiment, since the noise microphone 20 is directly attached to the outer panel 4, the distance D1 between the noise microphone 20 and the outer panel 4 is zero.
(4) In the first embodiment, the interior material 6 is provided in the vehicle interior space 2 on the side of the region 7 where the speaker is present, and the side of the region 7 faces the portion of the outer panel 4 where the noise microphone 20 is attached. The noise microphone 20 is provided in the space 8 between the outer panel 4 and the interior material 6. Accordingly, in general, the interior material 6 has soundproofing and sound absorption functions to make it difficult for the noise microphone 20 to pick up sounds in the region 7 where the speaker is present. Therefore, compared to the speech microphone 10, the noise microphone 20 is less likely to pick up sounds from the region 7 where the speaker is present, and is more likely to pick up noise that is propagated from outside the vehicle cabin to the outer panel 4 and emitted.
(5) In the first embodiment, the speech microphone 10 is attached to the support part 11 having the sound hole 12 connecting the region 7 where the speaker is present and the speech microphone 10, and is provided in the space 8 between the outer panel 4 and the interior material 6. Accordingly, the sound hole 12 connects the region 7 where the speaker is present to the speech microphone 10, making it easier for the speech microphone 10 to pick up sounds from the region 7 where the speaker is present compared to the noise microphone 20. Moreover, it becomes possible to provide both the speech microphone 10 and the noise microphone 20 in the space 8 between the outer panel 4 and the interior material 6.
(6) In the first embodiment, the distance L between the speech microphone 10 and the noise microphone 20 is within 1 meter. Accordingly, the results of experiments conducted by the inventors have shown that when the distance L between the speech microphone 10 and the noise microphone 20 is greater than 1 meter, the rate of reduction in coherence increases. Therefore, by setting the distance L between the speech microphone 10 and the noise microphone 20 to within 1 meter, the coherence between the speech microphone 10 and the noise microphone 20 can be increased. Therefore, the effect of reducing diffuse noise by the signal processor 30 becomes greater, and the SNR and the voice recognition rate can be improved.
(7) In the first embodiment, the noise microphone 20 is provided on the outer panel 4, which has a higher efficiency of emitting vibration sound into the air than the frame 3. This makes it possible for the noise microphone 20 to pick up noise with a higher sound pressure level than the noise radiated from the frame 3 among the multiple noises with different frequency characteristics contained in the diffuse noise picked up by the speech microphone 10. Therefore, the signal processor 30 can remove noise with a high sound pressure level that contributes greatly to reducing diffuse noise from the sound signal containing speech and noise acquired by the speech microphone 10, thereby increasing the amount of reduction in diffuse noise. As a result, the voice acquisition device can improve the SNR and improve the speech recognition rate for the speaker.
(8) In the first embodiment, the closed space in which the speaker who utters the target voice captured by the voice capture device is present is the interior space 2 of the vehicle 1 serving as a movable body. This can improve the voice recognition rate of the voice recognition system 50 that recognizes the voice of a speaker aboard a movable object.
(9) In the first embodiment, the noise microphone 20 is provided in the space 8 between the outer panel 4 and the interior material 6 that is included in the vehicle ceiling 5 of the movable body. Accordingly, vibrations of the movable body are propagated through structural parts such as the frame 3 by solid vibration, and are emitted into the vehicle interior as vibration noise from the outer panel 4 included in the vehicle ceiling 5 of the movable body. The vibration noise is a type of noise in which sound pressure is dominant among noises having different frequency characteristics contained in diffuse noise in the vehicle interior space 2. Therefore, by providing the noise microphone 20 in the space 8 between the outer panel 4 and the interior material 6 that are included in the vehicle ceiling 5 of the movable body, the vibration sound can be picked up by the noise microphone 20. Therefore, by using the signal processor 30 to remove the vibration sound signal from the sound signal containing speech and noise acquired by the speech microphone 10, the SNR and the voice recognition rate can be improved.
(10) In the first embodiment, the soundproofing material 40 surrounds the noise microphone 20 except for the side of the outer panel 4. Accordingly, the noise microphone 20 is surrounded by soundproofing material 40 on all sides except the outer panel 4 side, making it more difficult for it to pick up sound from the region 7 where the speaker is present than the speech microphone 10, and preventing a decrease in SNR due to signal processing.
(11) In the first embodiment, the inner wall surface 42 of the soundproofing material 40 has a structure in which the surfaces facing each other across the inner space 41 are not parallel to each other. This makes it possible to prevent the frequency characteristics of the sound signal emitted from the outer panel 4 into the inner space 41 and picked up by the noise microphone 20 from being changed due to resonance in the inner space 41 of the soundproofing material 40.

### Second Embodiment

The following describes a second embodiment of the present disclosure. In the second embodiment, the configurations of the speech microphone 10 and the signal processor 30 that differ from the first embodiment will be described.

As shown in FIG. 10, multiple speech microphones 10 are included in a microphone array. The multiple speech microphones 10 are provided in the space 8 between the outer panel 4 and the interior material 6, for example, while being attached to the support part 11. The support part 11 has multiple sound holes 12. The multiple sound holes 12 respectively connect the multiple speech microphones 10 and the region 7 in the vehicle interior space 2 where a speaker is present. This makes it easier for the multiple speech microphones 10 to pick up sounds from the region 7 in the vehicle interior space 2 where the speaker is present. For example, the number, arrangement, pitch, type, or sensitivity of the multiple speech microphones 10 can be set arbitrarily.

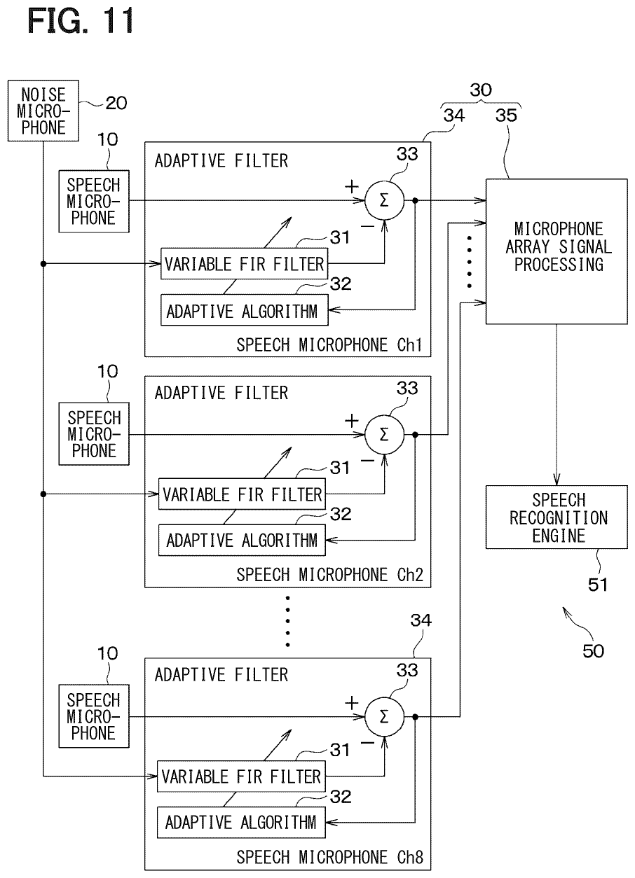

As shown in FIG. 11, the signal processor 30 of the second embodiment includes multiple adaptive filters 34 in the front stage and a microphone array signal processor 35 in the rear stage. In the present disclosure, the front stage may also be referred to as an initial stage, and the rear stage may also be referred to as a subsequent stage.

Each of the adaptive filters 34 includes, for example, a variable FIR filter 31, an adaptive algorithm execution unit 32, and an adder 33, and reduces diffuse noise. The variable FIR filter 31, the adaptive algorithm execution unit 32, and the adder 33 are similar to those described in the first embodiment. Multiple sound signals output from the multiple speech microphones 10 are input to the adders 33 of the corresponding adaptive filters 34, respectively. Moreover, the sound signal output from the noise microphone 20 is input to the adder 33 via the variable FIR filters 31 of the multiple adaptive filters 34. Each of the multiple adaptive filters 34 receives the sound signal acquired by the corresponding speech microphone 10 and the sound signal acquired by the noise microphone 20 as input signals and reduces diffuse noise. The multiple sound signals output from the multiple adaptive filters 34 are input to the microphone array signal processor 35.

The microphone array signal processor 35 receives sound signals processed by the adaptive filters 34 as input signals and performs directional noise reduction. The microphone array signal processor 35 may employ, for example, a delay time estimation method or a cross-correlation method. The microphone array signal processor 35 reduces directional noise by utilizing the arrival time difference of the multiple sound signals input from the multiple adaptive filters 34, respectively. The sound signal output from the microphone array signal processor 35 is input to the voice recognition engine 51.

The signal processor 30 provided in the voice acquisition device of the second embodiment described above includes multiple adaptive filters 34 in the front stage and a microphone array signal processor 35 in the rear stage. Accordingly, highly directional noises generated in the vehicle interior space 2, such as air conditioner wind noise and other people's speech, can be reduced by the subsequent microphone array signal processor 35, thereby improving the SNR and voice recognition rate. In addition, when the signal processing of the microphone array signal processor 35 includes processing other than that of a linear time-invariant system, by placing the microphone array signal processor 35 in the rear stage, it is possible to prevent the noise reduction effect of the adaptive filter 34 in the front stage from being degraded.

### Third Embodiment

The following describes a third embodiment. In the third embodiment, the configuration of the signal processor 30 is changed from that in the first embodiment, and the remaining parts are similar to those in the first embodiment, so only the difference from the first embodiment will be described.

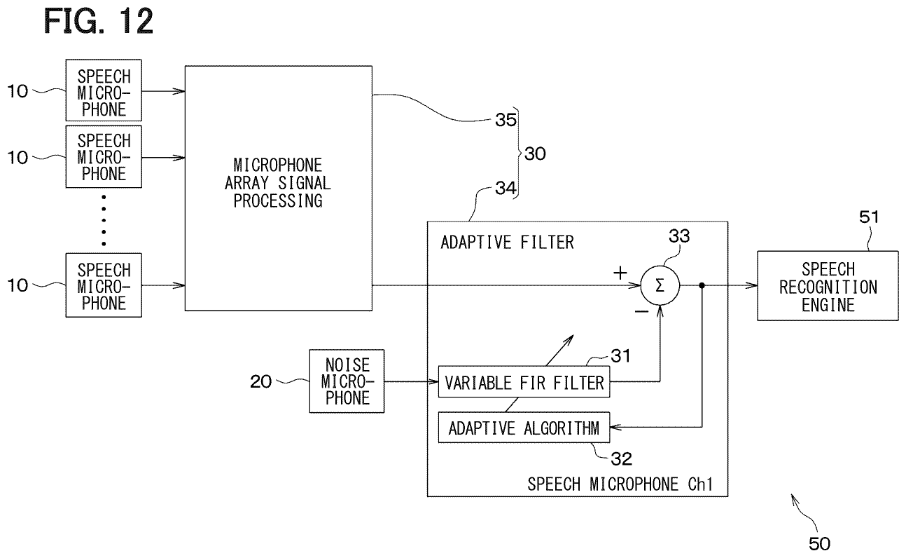

As shown in FIG. 12, the signal processor 30 of the third embodiment includes the microphone array signal processor 35 in the front stage and the adaptive filter 34 in the rear stage.

Multiple sound signals output from the speech microphones 10 are input to the microphone array signal processor 35. The microphone array signal processor 35 reduces directional noise by utilizing the arrival time difference of multiple sound signals input from the speech microphones 10, respectively. The microphone array signal processor 35 may employ, for example, a delay time estimation method or a cross-correlation method.

The sound signal output from the microphone array signal processor 35 is input to the adder 33 of the adaptive filter 34. Moreover, the sound signal output from the noise microphone 20 is input to the adder 33 of the adaptive filter 34 via the variable FIR filter 31 of the adaptive filter 34. The adaptive filter 34 receives the sound signal input from the microphone array signal processor 35 and the sound signal acquired by the noise microphone 20 as input signals, and reduces the diffuse noise. The sound signal output from the adaptive filter 34 is input to a voice recognition engine 51.

The signal processor 30 provided in the voice acquisition device of the third embodiment described above includes a microphone array signal processor 35 in the front stage and an adaptive filter 34 in the rear stage. Accordingly, the microphone array signal processor 35 located at the rear stage can reduce highly directional noise generated in the vehicle interior space 2, such as air conditioner wind noise and other people's speech, thereby improving the SNR and voice recognition rate. Furthermore, the signal processing by the adaptive filter 34 located at the front stage is one-channel processing, which reduces calculation costs.

### Fourth Embodiment

The following describes a fourth embodiment. In the fourth embodiment, the configuration of the signal processor 30 is changed from that in the first embodiment, and the remaining parts are similar to those in the first embodiment, so only the difference from the first embodiment will be described.

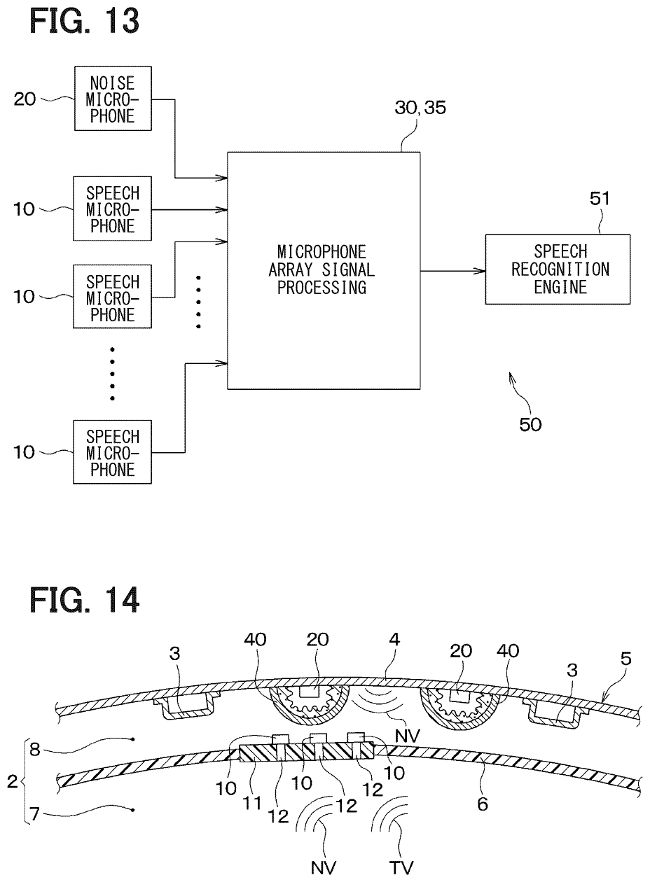

As shown in FIG. 13, the signal processor 30 of the fourth embodiment includes the microphone array signal processor 35. The multiple sound signals output from the speech microphones 10 and the sound signal output from the noise microphone 20 are both input to the microphone array signal processor 35. The microphone array signal processor 35 is capable of performing diffuse noise and directional noise reduction. The microphone array signal processor 35 may employ, for example, a delay time estimation method or a cross-correlation method. The sound signal output from the microphone array signal processor 35 is input to the voice recognition engine 51.

The signal processor 30 included in the voice recognition device according to the fourth embodiment described above includes the microphone array signal processor 35. According to this, by reducing diffuse noise and directional noise only by the microphone array signal processor 35, it becomes possible to eliminate signal processing by, for example, the adaptive filter 34, thereby reducing calculation costs.

### Fifth Embodiment

The following describes a fifth embodiment. In the fifth embodiment, the configuration of the noise microphone 20 is changed from that in the first embodiment, and the remaining parts are similar to those in the first embodiment, so only the difference from the first embodiment will be described.

As shown in FIG. 14, the voice acquisition device of the fifth embodiment includes multiple noise microphones 20. The multiple noise microphones 20 are provided on the outer panel 4 which is the same or a continuous plate-shaped part. In other words, the outer panel 4 has either a single piece or multiple consecutive pieces. More specifically, the multiple noise microphones 20 are provided in one area defined by the frame 3 within one outer panel 4. Each of the noise microphones 20 is surrounded by the soundproofing material 40.

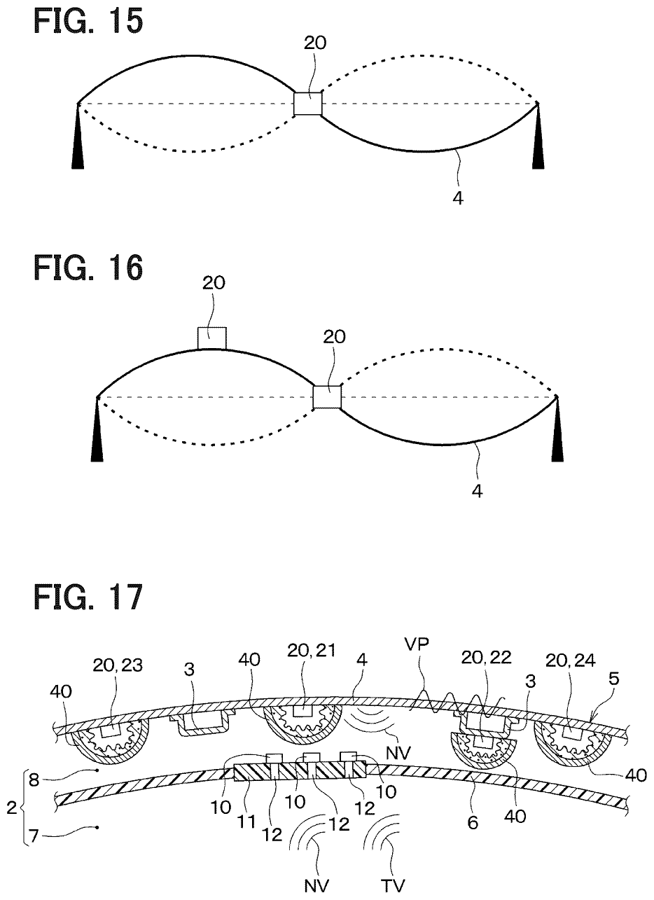

Here, the significance of providing multiple noise microphones 20 on the same or a continuous outer panel 4 will be explained. As shown in FIG. 15, when one noise microphone 20 is provided on the same or continuous outer panel 4, if the noise microphone 20 is located at a node of vibration, there is a possibility that the air will not vibrate in the inner space 41 of the soundproofing material 40, making it difficult to capture noise.

In contrast, in the fifth embodiment, as shown in FIG. 16, by providing the multiple noise microphones 20 on the same or continuous outer panel 4, even if one noise microphone 20 is located at a vibration node, it is possible for another noise microphone 20 to pick up noise.

The voice acquisition device of the fifth embodiment described above includes the multiple noise microphones 20 on the same or continuous outer panel 4. Accordingly, even if the position of a vibration node of the outer panel 4 coincides with the position of one noise microphone 20, the vibration sound can be picked up by another noise microphone 20. Furthermore, compared to signal processing using one noise microphone 20, the SNR can be further improved by acquiring and reducing vibration sounds of multiple vibration modes.

### Sixth Embodiment

The following describes a sixth embodiment. In the sixth embodiment, the configuration of the noise microphone 20 is changed from that in the first embodiment, and the remaining parts are similar to those in the first embodiment, so only the difference from the first embodiment will be described.

As shown in FIG. 17, the voice acquisition device of the sixth embodiment also includes multiple noise microphones 20. In the sixth embodiment, the multiple noise microphones 20 are referred to as first to fourth noise microphones 21 to 24, respectively. The number of the noise microphones 20 is not limited to four, but can be set arbitrarily.

The first noise microphone 21 is provided on the outer panel 4. In detail, the first noise microphone 21 is provided in a predetermined area defined by the frame 3 within the outer panel 4.

On the other hand, the second to fourth noise microphones 22 to 24 are provided in components (e.g., the frame 3) other than the outer panel 4 that form the closed space, or in a different area of the outer panel 4 partitioned off by the frame 3. Specifically, the second noise microphone 22 is provided on the frame 3. The third noise microphone 23 and the fourth noise microphone 24 are provided in different areas of the outer panel 4 defined by the frame 3. Each of the noise microphones 20 is surrounded by the soundproofing material 40.

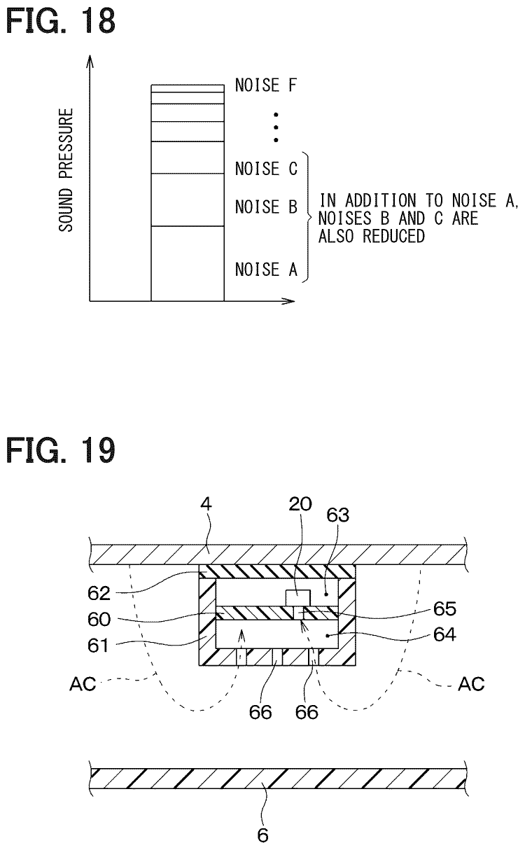

Here, the significance of providing the multiple noise microphones 20 at different locations will be described. As explained in the first embodiment with reference to FIGS. 6 to 8, the noises A to F from multiple directions contained in the diffuse noise acquired by the noise microphone 20 each have different frequency characteristics because the locations from which the sound is emitted are different. Therefore, as shown in FIG. 18, by providing the multiple noise microphones 20 at different locations, it is possible to capture noises B, C, etc. in addition to noise A, among the noises A to F with different frequency characteristics contained in diffuse noise, using the multiple noise microphones 20. Then, in the signal processor 30, signal processing is performed to subtract noises A, B, C, etc. acquired by the multiple noise microphones 20 from the sound signal acquired by the speech microphone 10, thereby making it possible to further improve the SNR.

Among the multiple noise microphones 20 included in the voice acquisition device of the sixth embodiment described above, the predetermined noise microphone 20 is provided on the predetermined outer panel 4. On the other hand, another microphone among the multiple noise microphones 20 is provided in a part other than the specified outer panel 4 among the parts forming the closed space, or in another area within the specified outer panel 4 that is partitioned by the frame 3. Among the parts that form the closed space, the parts other than the specified outer panel 4 are, for example, the frame 3 or another outer panel. This makes it possible to reduce vibration noise with different frequency characteristics emitted from parts that form the closed space other than the specified outer panel 4, compared to signal processing using a single noise microphone 20, thereby further improving the SNR.

### Seventh Embodiment

The seventh embodiment will be described. The seventh embodiment modifies the method of attaching the noise microphone 20 to the outer panel 4, which is a plate-shaped part, compared to the first embodiment and others. Since the other aspects are the same as in the first embodiment and others, only the parts that differ from the first embodiment and others will be explained.

As shown in FIG. 19, in the seventh embodiment, the noise microphone 20 mounts on a printed circuit board 60 and disposed inside a box-shaped housing 61. The housing 61 is attached to the outer panel 4 with a vibration-resistant material 62 sandwiched therebetween. Therefore, it can be said that the noise microphone 20 is attached to the outer panel 4 via parts fixed to the outer panel 4 (for example, the vibration-resistant material 62, the housing 61, and the printed circuit board 60). The vibration-resistant material 62 may also be referred to as a vibration-damping material.

The vibration-resistant material 62 is made of an elastic material such as rubber or urethane foam that easily absorbs vibrations, and is provided between the outer panel 4 and the housing 61. Therefore, the vibration-resistant material 62 can suppress the transmission of vibrations of the outer panel 4 to the noise microphone 20 via the housing 61.

The space inside the housing 61 is divided into a first space 63 and a second space 64 by the printed circuit board 60. The first space 63 is a space on the outer panel 4 side of the printed circuit board 60. The second space 64 is a space on the opposite side of the printed circuit board 60 from the outer panel 4. The noise microphone 20 mounts on the surface of the printed circuit board 60 facing the first space 63. The printed circuit board 60 has a sound hole 65 that connects the noise microphone 20 and the second space 64. Furthermore, the housing 61 has a sound hole 66 that connects the space outside the housing 61 to the second space 64. Therefore, as shown by the dashed arrow AC, the vibration sound emitted by the vibration of the outer panel 4 travels from the space outside the housing 61, through the sound hole 66 in the housing 61, the second space 64, and the sound hole 65 in the printed circuit board 60, and is transmitted to the noise microphone 20.

An interior material 6 is provided on the vehicle lower side (i.e., the seat side) of the housing 61. Therefore, it can be said that the noise microphone 20 is positioned so that it is difficult to pick up sounds from the region 7 where the speaker is present, but is easy to pick up sounds that propagate from outside the vehicle interior space 2 to the outer panel 4 and are radiated.

The voice acquisition device of the seventh embodiment described above includes the vibration-resistant material 62 between the outer panel 4 and the noise microphone 20. Accordingly, the vibration of the noise microphone 20 in association with the vibration of the outer panel 4 can be suppressed by the vibration-resistant material 62. Therefore, it is possible to prevent the frequency characteristics of the noise picked up by the noise microphone 20 from changing due to vibration of the noise microphone 20. In addition, it is possible to prevent the frequency characteristics of the vibration of the outer panel 4 propagating to the noise microphone 20 from being changed due to the method of attaching the noise microphone 20 to the outer panel 4.

### Eighth Embodiment

The following describes an eighth embodiment. The eighth embodiment is different from the first embodiment in that the method of attaching the noise microphone 20 to the outer panel 4 as a plate-shaped part is changed, but other aspects are similar to the first embodiment, so only the parts that differ from the first embodiment will be described.

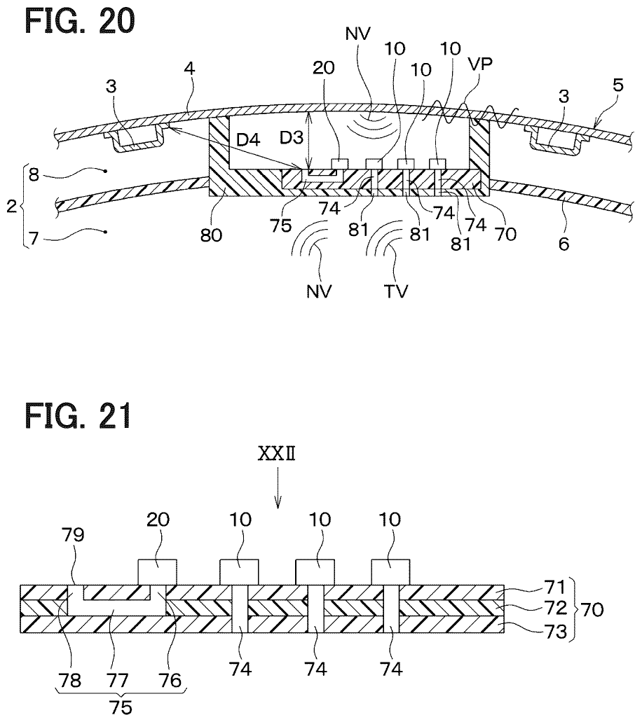

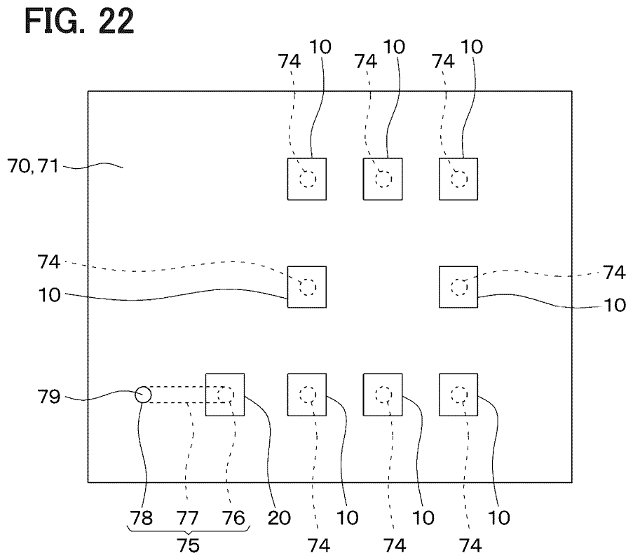

As shown in FIGS. 20 to 22, in the eighth embodiment, the speech microphone 10 and the noise microphone 20 mount on one surface of a multilayer printed circuit board 70 in the board thickness direction. Specifically, for example, eight speech microphones 10 and one noise microphone 20 mount on one surface of the multilayer printed circuit board 70 in the board thickness direction.

The multilayer printed circuit board 70 is stored in a rear seat entertainment device 80 (hereinafter referred to as “RSE 80”), which is an example of the support part 11. The RSE 80 is in contact with the outer panel 4. Therefore, both the noise microphone 20 and the speech microphone 10 mount on the outer panel 4 via a support part (e.g., RSE 80) fixed to the outer panel 4. The RSE 80 and the multilayer printed circuit board 70, together with the interior material 6, separate the region 7 in which the speaker is present from the space 8 between the outer panel 4 and the interior material 6. Therefore, sound from the region 7 where the speaker is present is less likely to enter the space 8 between the outer panel 4 and the interior material 6.

As shown in FIG. 21, the multilayer printed circuit board 70 is, for example, a three-layer printed circuit board. In the following, the layer of the multilayer printed circuit board 70 on which the speech microphone 10 and the noise microphone 20 are mounted will be referred to as the first layer 71, the next layer will be referred to as the second layer 72, and the layer opposite the first layer 71 will be referred to as the third layer 73.

The multilayer printed circuit board 70 has speech sound holes 74 at positions on which the eight speech microphones 10 mount, and has the noise sound holes 75 at positions on which the noise microphones 20 mount. The speech sound hole 74 penetrates the third layer 73 from the first layer 71 to of the multilayer printed circuit board 70. As shown in FIG. 20, the RSE 80 also has a sound hole 81 at a position corresponding to the noise sound hole 75. As a result, the speech sound hole 74 connects the region 7 where the speaker is present and the speech microphone 10. Therefore, sound from the region 7 where the speaker is present is transmitted to the speech microphone 10 via the sound hole 81 of the RSE 80 and the speech sound hole 74. Therefore, each of the eight speech microphones 10 can easily pick up sounds from the region 7 in the vehicle interior space 2 where the speaker is present.

As shown in FIG. 21, the noise sound hole 75 is formed in a U-shape when viewed in cross section of the multilayer printed circuit board 70. Specifically, the noise sound hole 75 is made up of first to third hole portions 76 to 78. The first hole portion 76 is provided in the first layer 71 at a position on which the noise microphone 20 mounts. The third hole 78 is provided in a position on the first layer 71 on which neither the noise microphone 20 nor the speech microphone 10 mounts. The second hole portion 77 is provided to extend in the in-plane direction in the second layer 72, and connects the first hole portion 76 and the second hole portion 77. As a result, the noise sound hole 75 communicates the space 8 between the outer panel 4 and the interior material 6 with the noise microphone 20. In addition, the distance D3 between the opening 79 of the third hole portion 78 of the noise sound hole 75 and the outer panel 4 is closer than the distance D4 between the opening 79 of the third hole portion 78 and the frame 3. Therefore, the vibration sound emitted from the outer panel 4 is easily transmitted to the noise microphone 20 via the noise sound hole 75. Therefore, the noise microphone 20 is less likely to pick up sounds from the region 7 in the vehicle interior space 2 where the speaker is present, and is more likely to pick up sounds emitted from the outer panel 4 than sounds radiated from the frame 3.

In the voice acquisition device of the eighth embodiment described above, the speech microphone 10 and the noise microphone 20 mount on a multilayer printed circuit board 70. The multilayer printed circuit board 70 has the speech sound hole 74 for speech and the noise sound hole 75 for noise. Accordingly, by mounting the speech microphone 10 and the noise microphone 20 on the same board, degradation of signal quality can be prevented in the case of analog signals, and degradation of electromagnetic compatibility (i.e., EMC) can be prevented in the case of digital signals. EMC is an abbreviation for Electromagnetic Compatibility. Furthermore, by mounting the speech microphone 10 and the noise microphone 20 on the same multilayer printed circuit board 70, the number of steps required to install a voice acquisition device in the vehicle 1 can be reduced.

Furthermore, in the eighth embodiment, the speech microphone 10 and the noise microphone 20 mount on one surface of the multilayer printed circuit board 70 in the board thickness direction. According to this, by mounting the speech microphone 10 and the noise microphone 20 on one side of the multilayer printed circuit board 70, the mounting cost can be reduced.

### Ninth Embodiment

The following describes a ninth embodiment. The ninth embodiment has a configuration in which the interior material 6 is omitted from the first embodiment and the like, but other aspects are similar to the first embodiment and the like, so only the parts that differ from the first embodiment and the like will be described.

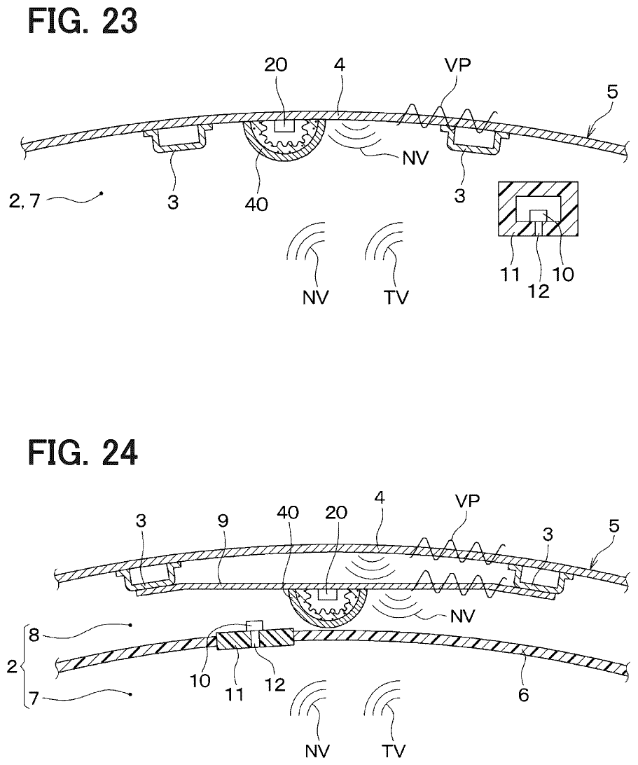

As shown in FIG. 23, in the ninth embodiment, no interior material 6 is provided in the vehicle interior space 2. However, the noise microphone 20 is attached to the outer panel 4, and the soundproofing material 40 is provided around the noise microphone 20, as in the first embodiment. Therefore, the noise microphone 20 has difficulty picking up sounds from the region 7 where the speaker is present, and is more likely to pick up sounds emitted from the outer panel 4 than from the frame 3. The speech microphone 10 can be installed anywhere within 1 meter from the noise microphone 20.

The ninth embodiment described above can thus have the effect similar to that of the first embodiment.

### Tenth Embodiment

The following describes a tenth embodiment. The tenth embodiment has a configuration in which the position at which the noise microphone 20 is attached is changed, and other aspects are similar to the first embodiment, etc., so only the parts that differ from the first embodiment, etc. will be described.

As shown in FIG. 24, in the tenth embodiment, the noise microphone 20 is attached to a plate-shaped bracket 9 as an example of a plate-shaped part. The plate-shaped bracket 9 is provided between the outer panel 4 and the interior material 6, and is a bracket for mounting interior parts such as interior lighting. The plate-shaped bracket 9 is an example of a plate-shaped part that has a higher efficiency of emitting vibration noise into the air than the frame 3. The efficiency is determined by the thickness, density, Young's modulus, area, and Poisson's ratio of the member.

In the tenth embodiment described above, the plate-shaped part to which the noise microphone 20 is attached is the plate-shaped bracket 9 that is provided between the outer panel 4 and the interior material 6 for mounting the interior part. Accordingly, vibrations of the movable body are propagated through structural parts such as the frame 3 by solid vibration, and are radiated into the vehicle interior from, for example, the outer panel 4 and the plate-shaped bracket 9 as vibration noise. The vibration noise is a type of noise with a relatively high sound pressure among noises with different frequency characteristics contained in the diffuse noise in the vehicle interior space 2. Therefore, by providing the noise microphone 20 on the plate-shaped bracket 9, the vibration sound can be picked up by the noise microphone 20. Therefore, by using the signal processor 30 to remove the vibration sound signal from the sound signal containing speech and noise acquired by the speech microphone 10, the SNR and the voice recognition rate can be improved.

### Other Embodiments

(1) In each of the above embodiments, the soundproofing material 40 is provided to surround the noise microphone 20, but this is not limited to the above. For example, if the interior material 6 is provided between the region 7 where the speaker is present and the outer panel 4 in the closed space, the soundproofing material 40 may be omitted.
(2) In each of the above embodiments, the outer panel 4 of the ceiling of a movable body is given as an example of a plate-shaped part that forms a closed space. However, it is not limited to this example, and may be, for example, an exterior panel of, for example, a side door, an exterior panel of a rear door, and a dash panel that form the interior of the vehicle 1.
(3) In each of the above embodiments, an electric circuit is given as an example of the signal processor 30. However, the present disclosure is not limited to this. For example, the signal processor 30 may be configured as an electronic control unit.
(4) In each of the above embodiments, a vehicle is given as an example of a movable body to which the voice acquisition device is adapted. However, the movable body is not limited to this example. For example, the movable body may be a train, an airplane, a ship, or the like.

The present disclosure is not limited to the embodiments described above, but can be modified appropriately within the scope of the present disclosure. The above-described embodiments and a part thereof are not irrelevant to each other, and can be appropriately combined with each other unless the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. In each of the embodiments, when referring to the shape, positional relationship, and the like of the constituent elements and the like, the shape, positional relationship, and the like are not limited unless otherwise specified or limited to a specific shape, positional relationship, and the like in principle.

The control unit and the method thereof described in the present disclosure may be realized by a dedicated computer provided by configuring a processor and a memory programmed to execute one or a plurality of functions embodied by a computer program. Alternatively, the control unit and the method described in the present disclosure may be implemented by a special purpose computer configured as a processor with one or more special purpose hardware logic circuits. Alternatively, the control unit and the method which are described in the present disclosure may be realized by one or more dedicated computers configured to include a combination of a processor and a memory which are programmed to fulfil one or more functions and a processor configured to include one or more hardware logic circuits. The computer program may be stored in a computer-readable non-transitory tangible recording medium as an instruction executed by the computer. The memory of the ECU is a non-transitory tangible storage medium.

What is claimed is:

1. A voice acquisition device configured to be adapted to a voice recognition system, the voice recognition system configured to recognize a voice of a speaker present in a closed space formed by components including a skeletal component and a plate-shaped component, the voice acquisition device comprising:
a speech microphone configured to acquire a sound from a region where the speaker is located, the region located in the closed space;
a noise microphone located to acquire a lower level of the sound from the region than the speech microphone, the noise microphone located to acquire a higher level of a sound emitted from the plate-shaped component compared to a sound emitted from the skeletal component among sounds caused by vibrations propagating from outside of the closed space; and
a signal processor configured to reduce a noise based on input signals, the input signals including
a time-series sound signal acquired by the speech microphone, and
a time-series sound signal acquired by the noise microphone.

2. The voice acquisition device according to claim 1, wherein
the noise microphone is either directly attached to the plate-shaped component, or attached to the plate-shaped component via a component that is fixed to the plate-shaped component.

3. The voice acquisition device according to claim 2, wherein
a distance between the noise microphone and the plate-shaped component is shorter than a distance between the noise microphone and the skeletal component.

4. The voice acquisition device according to claim 3, wherein
the plate-shaped component has a part to which the noise microphone is attached,
an interior material is located between the region and the part in the closed space, and
the noise microphone is located in a space between the plate-shaped component and the interior material.

5. The voice acquisition device according to claim 4, wherein
the speech microphone is attached to a component having a sound hole that connects the speech microphone and the region, and is located in the space between the plate-shaped component and the interior material.

6. The voice acquisition device according to claim 4, wherein
the noise microphone is attached to a component having a noise sound hole that connects the space and the noise microphone, and is located in the space between the plate-shaped component and the interior material, and
a distance between an opening of the noise sound hole and the plate-shaped component is shorter than a distance between the opening of the noise sound hole and the skeletal component.

7. The voice acquisition device according to claim 1, wherein
the speech microphone is one of speech microphones included in a microphone array, and
the signal processor includes:
adaptive filters at a front stage, the adaptive filters configured to reduce a diffuse noise based on input signals, the input signals including time-series sound signals acquired by the speech microphones and the time-series sound signal acquired by the noise microphone; and
a microphone array signal processor at a rear stage, the microphone array signal processor configured to reduce a directional noise based on input signals, the input signals including time-series sound signals processed by the adaptive filters.

8. The voice acquisition device according to claim 1, wherein
the speech microphone is one of speech microphones included in a microphone array,
the signal processor includes:
a microphone array signal processor at a front stage, the microphone array signal processor configured to reduce a directional noise based on input signals including time-series sound signals acquired by the speech microphones;
an adaptive filter at a rear stage, the adaptive filter configured to reduce a diffuse noise based on input signals, the input signals including time-series sound signals processed by the microphone array signal processor and the time-series sound signal acquired by the noise microphone.

9. The voice acquisition device according to claim 1, wherein
the speech microphone is one of speech microphones included in a microphone array, and
the signal processor is a microphone array signal processor configured to reduce a diffuse noise and a directional noise based on input signals, the input signals including time-series sound signals acquired by the speech microphones and a time-series sound signal acquired by the noise microphone.

10. The voice acquisition device according to claim 1, wherein
a distance between the speech microphone and the noise microphone is one meter or shorter.

11. The voice acquisition device according to claim 1, wherein
the noise microphone is either directly attached to the plate-shaped component, or attached to the plate-shaped component via a component that is fixed to the plate-shaped component, and
the plate-shaped component has a higher efficiency of emitting a vibration sound into air than the skeletal component.

12. The voice acquisition device according to claim 1, wherein
the closed space is a space inside a movable body, and
the space is configured to accommodate the speaker on board the movable body.

13. The voice acquisition device according to claim 12, wherein
the plate-shaped component has a part to which the noise microphone is attached,
an interior material is located between the region and the part in the closed space,
the noise microphone is located in a space between the interior material and the plate-shaped component that is included in in a ceiling of the movable body.

14. The voice acquisition device according to claim 12, wherein
the plate-shaped component has a part to which the noise microphone is attached,
an interior material is located between the region and the part in the closed space, and
the plate-shaped component is either
an outer panel that is included in an outer shell of the movable body, or
a plate-shaped bracket that is located between the outer panel and the interior material to install an interior component of the movable body.

15. The voice acquisition device according to claim 1, wherein
the noise microphone is one of noise microphones,
the noise microphones are located at the plate-shaped component that has either a single piece or consecutive pieces.

16. The voice acquisition device according to claim 1, wherein
the noise microphone is one of noise microphones,
a predetermined noise microphone among the noise microphones is located at a predetermined plate-shaped component, and
another of the noise microphones is located at either
a component other than the predetermined plate-shaped component among the components forming the closed space, or
another region partitioned by the skeletal component inside the predetermined plate-shaped component.

17. The voice acquisition device according to claim 1, further comprising:
a soundproofing material surrounding the noise microphone, except for a location facing the plate-shaped component.

18. The voice acquisition device according to claim 17, wherein
the soundproofing material includes an inner space in which the noise microphone is provided,
the soundproofing material includes an inner wall surface having surface portions forming the inner space of the soundproofing material, and
the surface portions are positioned opposite each other with the inner space between the surface portions, and are not parallel to each other.

19. The voice acquisition device according to claim 1, further comprising:
a vibration-resistant material located between the plate-shaped component and the noise microphone.

20. The voice acquisition device according to claim 4, wherein
the speech microphone and the noise microphone mount on a multilayer printed circuit board, and
the multilayer printed circuit board has:
a speech sound hole that connects the speech microphone and the region, and
a noise sound hole that connects the noise microphone and the space between the plate-shaped component and the interior material.

21. The voice acquisition device according to claim 20, wherein
the speech microphone and the noise microphone mount on one surface of the multilayer printed circuit board in a thickness direction of the multilayer printed circuit board.

22. The voice acquisition device according to claim 1, wherein
the plate-shaped component has a part to which the noise microphone is attached, and
the plate-shaped component has a larger area than the skeletal component.
